(19) United States
(12) Patent Application Publication
(10) Pub. No.: US 2006/0152720 A1
(43) Pub. Date: Jul. 13, 2006

(54) Method and device for the detection of the presence, and the real-time analysis of, chemical and/or biological substances in the atmosphere

(75) Inventors: Henri Lancelin, Morangis (FR); Patrick Bleuse, Le Quesnoy (FR); Pierre Clausin, Ville D'Avray (FR)

Correspondence Address: BROWDY AND NEIMARK, P.L.L.C.;624 NINTH STREET, NW, SUITE 300, WASHINGTON, DC, 20001-5303, US

(73) Assignee: PROENGIN, Saint Cyr l'Ecole (FR)

(21) Appl. No.: 10/531,717

(22) PCT Filed: Oct. 9, 2003
(86) PCT No.: PCT/FR03/02977

§ 371 Date: Apr. 18, 2005

(30) Foreign Application Priority Data
Oct. 18, 2002 (FR) 02/13033

(51) Int. Cl. G01J 3/30

(52) U.S. Cl. 356/315

(57) ABSTRACT

The invention relates to a device for analysing a gaseous composition by means of flame spectrophotometry, which can be used to identify a current test spectrum and which is based on a knowledge acquisition and diagnostic method. The inventive method comprises the following steps: the main component analysis of reduced data from the current spectrum; the creation of a matrix representing the set of projected spectra of the set of active elements; the classification of the set of projected spectra of the set of active elements into current groups; the evaluation of the membership potential of the current spectrum in relation to all of the current groups; the membership of the current spectrum to one of the current groups of the set of active elements if the membership potential to said group of said current spectrum is greater than a pre-determined threshold; the triggering of the alarm if one of the current groups of the set of active elements presents an appearance frequency for different elements of the group which is greater than a pre-determined threshold; and remote rejection of the current spectrum and agglomeration to one of the groups being formed if said current spectrum departs sufficiently from the existing forms in order to form part of a new group.

The invention relates to a method and a device to detect chemical and/or biological substances in the atmosphere and real time analysis of them.

It advantageously integrates, but not exclusively, within an apparatus for analysing a gaseous mix via flame spectrophotometry for example of the type disclosed in the patent FR No 98 00761 filed by the applicant.

Generally speaking we know that flame spectrophotometry is a method consisting in performing a spectrographic analysis of the radiation produced by the flame of a gaseous mix including the elements to be analysed and a comburant gas such as hydrogen. This analysis is carried out by isolating the specific radiations of the desired elements and by reading, via photometric means, these radiations.

In order to apply this method to some elements which do not engender any specific luminous emissions, it is necessary to provoke, prior to combustion, a reaction between these elements and a reactive element so as to obtain a compound producing a detectable and identifiable luminous emission.

This prior reaction can be created by performing a first combustion with a reactive.

The gaseous mix generated from this first combustion is subjected to a second combustion which produces a luminous emission on which we also carry out a spectrographic analysis.

The information provided by photometric means, relating to the specific radiations depending on the nature of the desired elements and the intensity of lines according to the concentration of said elements, can be transmitted to a processor programmed to interpret this information, whether it be of compounds, chemical substances or even biological substances.

Generally, we know that sometimes it is necessary to be able to efficiently intervene in the event of atmospheric contamination; in which case it is appropriate to rapidly detect and identify the elements constituting said contamination.

Moreover, the complexity of the radiation spectrums associated with the large number of desired elements require the implementing of methods that allow to acquire the current spectrum to be analysed and its identification compared to a known spectrum referral base, and this in real time.

More precisely, the purpose of the invention is to improve the results of these analyses by maximising the range of biological substances that can be analysed and by improving the trustworthiness of the obtained results.

For this reason, it proposes a training and diagnostic process in order to identify a current spectrum to be analysed, according to the following steps:
the analysis of the reduced data of the current spectrum in principal components;
the creation of a matrix representing all the projections of the set of actives;
the classification of all the projections of the set of actives into current groups;
the evaluation of the potential of affiliation of the current spectrum in all the current groups;
the affiliation of the current spectrum to one of the current groups of the set of actives if the potential of affiliation to said group of said current spectrum is greater than a pre-set threshold;
the setting off of the alarm if one of the current groups of the set of actives has a frequency of appearance of the different elements of the group greater than a pre-set threshold,
the remote rejection of the current spectrum and the agglomeration of one of the training groups, if said current spectrum is sufficiently different to extant forms so as to belong to a new group.

Advantageously, the training and diagnostic process will be designed so as to allow, prior to the above steps:
the modelling of the bottom of the flame; the deleting of the bottom of the flame at the current spectrum;
the filtering of the obtained signal;
the standardising of the filtered spectrum;
the detecting of the current spectrum if the latter does not correspond to noise.

Of course, this modelling of the situations, where the number of variables associated with each spectrum is much greater than the number of spectrums, allows to distinguish the specific spectrums of the elements constituting a contamination.

An embodiment of the invention will be described below, by way of non-restrictive example, in reference to the annexed drawings in which:

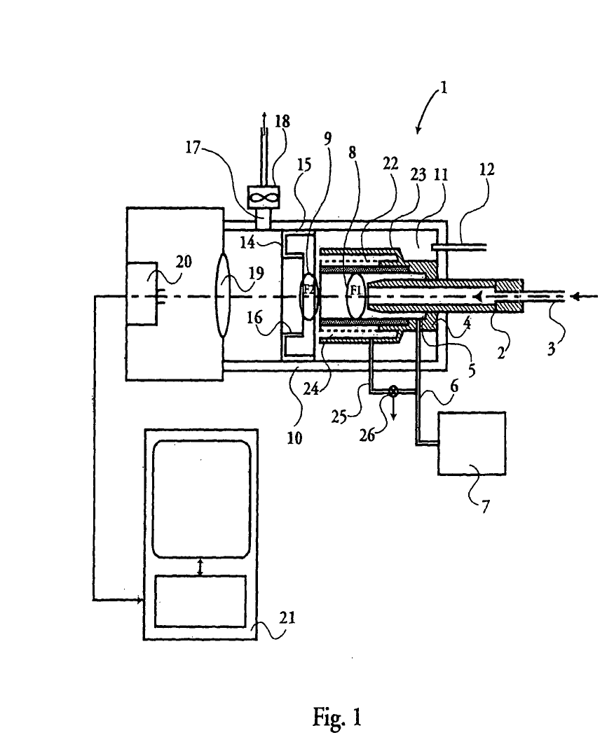

FIG. 1 is a schematic diagram of an apparatus for analysing chemical and/or biological substances via spectrophotometry;

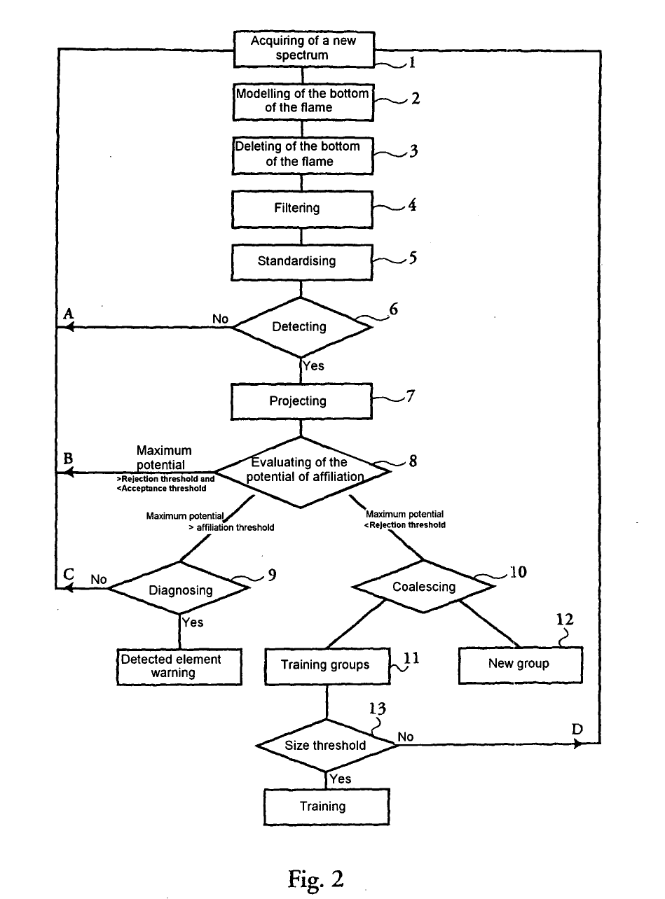

FIG. 2 is the flowchart of the training and diagnostic process.

The apparatus for analysing via spectrophotometry can incorporate, as seen in FIG. 1, a tubular burner 1 comprising a tubular nozzle 2 connected to an inlet pipe 3 for the gas to be analysed and open at the other side and, in a coaxial manner to this nozzle 2:
a first tubular sleeve 4, with a slightly bigger diameter than that of the nozzle 2 and axially shifted compared to the latter, so as to delimit, on one hand, with the nozzle 2, a first annular intake chamber 5 connected to an injection circuit 6 for hydrogen issuing from a source 7 and, on the other hand, beyond the first nozzle 2, a combustion chamber 8 in which the partial combustion of the gas to be analysed and the hydrogen generates a first flame F1: this first tubular sleeve 4 closes off at one side on the nozzle 2 and opens out, at the other side, into a second combustion chamber 9;
a second tubular sleeve 10, with a bigger diameter than that of the first tubular sleeve 4 and delimiting with the latter, a second intake chamber 11 connected to an intake circuit 12 for gas or an oxidising gaseous mix, for example air: this second sleeve 10 closes off on one side on the nozzle 2 and/or on the first sleeve 4 and delimits, on the other side, beyond the latter, the second combustion chamber 9, in which post-combustion takes place in an oxidising medium of the gas that issued from the first combustion chamber 8 and from the intake chamber 11;
an annular electrode 14, is split substantially in the form of an inverted C, interlocked on its side with the biggest diameter 15 to the second sleeve 10, and whose side with the smallest diameter 16, whose axial length is smaller than that of the side 15, delimits an outlet pipe S of the combustion chamber 9: beyond the electrode 14 (on the opposite side of the sleeve 4), the sleeve 10 comprises a lateral orifice 17 on which an exhaust pipe opens into, fitted with a turbine 18 actuated by a non-represented engine;
a focusing optic 19 such as a lens fitted into the circular opening of a cap closing off the sleeve 10, on the opposite side to the nozzle 2, this focusing optic 19 being designed so as to focus the luminous radiation emitted in the two combustion chambers 8, 9, in particular the first chamber 8, on the inlet orifice of a spectrophotometry assembly.

The information provided by the spectrometry assembly 20 is transmitted to a processor/display unit 21 programmed so as to determine the nature and the concentration of the desired elements of the gas sample conveyed by the nozzle 2.

As mentioned above, the external surface of the sleeve 4 can be covered by a coating 22 of a material capable of emitting a gas reactive with the temperature to which this sleeve 4 is raised to under the effect of the combustion generated in the first chamber 8. By way of example, this reactive material can consist in indium, the desired element being chlorine.

In this case, the burner can comprise a third tubular coaxial sleeve 23 extending into the dividing space lying between the sleeves 4 and 10. This third sleeve 23 delimits along with the sleeve 4 an annular chamber 24 opening out into the second combustion chamber 9 and acting as the intake into this chamber 9 of a flow of hydrogen issuing from the source 7. For this reason, the annular chamber 24 is connected to the source 7 by means of an intake circuit 25 controlled by a valve 26.

The aforementioned burner operates as follows:

The entire two chambers are put under negative pressure by the turbine 18 so as to provoke a suction of gas to be sampled in the nozzle 2, through an orifice made in the intake circuit 3.

On the inside of the sleeve 4, the flow of drawn gas (for example air) mixes with the hydrogen current injected via the intake chamber 5, on a proportion such that the combustion produced in the first combustion chamber 8 is reductive. The luminous radiation generated by the flame F1 present in the first chamber 8 allows to detect, thanks to the spectrophotometry assembly 20, compounds such as phosphor and sulphur and deduce the presence of desired elements.

The temperature generated by this combustion provokes the heating of the sleeve 4 and, consequently, of the coating 22.

When it reaches or exceeds its evaporating temperature, this coating 22 emits a reactive vapour which mixes with the hydrogen flow injected via the intake chamber 24 and with air issuing from the intake chamber 11.

At the outlet of these chambers 11 and 24, the gaseous mix reacts (oxidising combustion) with the gaseous flow resulting from the partial combustion produced in the chamber 8 to produce the flame F2 which emits a light characteristic of a component such as chlorine which has reacted with the reactive indium vapour. This light, as with that produced in the chamber 8, is focused by the lens 19 at the opening of the spectrophotometry assembly 20.

The information provided by the assembly 20 is transmitted to the processor 21, which is programmed so as to interpret this information and deduce the nature and the concentration of the desired elements, whether they are compounds, chemical substances or even biological substances.

This said information is in the form of radiation spectrum with different wavelengths and different intensities. They constitute a set of data associated with a plurality of variables relating to a plurality of desired elements.

The method allowing to identify the current spectrum consists in creating a set of actives beforehand, that being a set of pre-processed spectrums according to predefined rules, these spectrums are agglomerated into distinct groups then in trying for each current spectrum to identify the group, among the set of actives, for which the affiliation of said current spectrum is the strongest, and in determining the group that obtained the sufficient size to be considered as being the result of the diagnostic.

The constitution of the set of actives, as well as the processing of a current spectrum uses the same method for processing data represented in FIG. 2.

In this example, the method for processing said data can comprise the following steps:
acquiring of a new spectrum (block 1),
modelling of the bottom of the flame (block 2),
deleting of the bottom of the flame (block 3),
filtering of the obtained signal (block 4),
standardising of the pre-processed spectrum (block 5),
detecting of the obtained spectrum (block 6),
projecting of the obtained spectrum (block 7),
evaluating of the potential of affiliation of the projected spectrum (block 8),
diagnosing (block 9),
coalescing (block 10),
agglomerating one of the training groups (block 11),
creating of a new group (block 12),
size threshold (block 13),

The acquiring of a new spectrum (block 1) relates to the taking into consideration said information derived from the assembly 20; it can also relate to the first step of the further taking into account of a non-processed spectrum in the method during some steps detailed later on.

The modelling of the bottom of the flame (block 2) allows to update the stored digital data that defines the characteristics of the radiation generated by the flame, in the absence of elements to be analysed.

The deleting of the bottom of the flame (block 3) consists in extracting, from the current spectrum to be analysed, the modelling data of the bottom of the flame.

The filtering of the obtained signal (block 4) is performed using a Butterworth recursive linear filter of order one.

The standardising of the pre-processed spectrum (block 5) consists in carrying out the determining of the variables of the spectrum in the form of reduced centre matrix.

The detecting of the obtained spectrum (block 6), after pre-processing, allows to know whether the current spectrum has clearly superior characteristics to normal noise, in which case we consider that there has been an enhancement; consequently, a specific spectrum appears; otherwise, the obtained signal is directed towards the block 1, arrow A, for a repeat pre-processing.

The projection of the detected spectrum (block 7), on all the projection axes, consists in estimating the parameters of the spectrum with the use of a series of simple regressions between the data of said spectrum and a part of its parameters; this estimation uses the NIPALS (Non-linear estimation by Iterative Partial Least Squares) algorithm.

The evaluating of the potential of affiliation (block 8), of the projected spectrum in relation to the different spectrum groups, previously processed according to the same process, and constituting a set of actives organised in distinct groups, is performed in the following manner:
if the potential of affiliation of the current spectrum is greater than a pre-set threshold, said spectrum undergoes the following step, brown as the diagnostic step (block 9),
if the potential of affiliation of the current spectrum is less than a pre-set rejection threshold, said spectrum undergoes the step known as the coalescence step (block 10),
if the potential of affiliation of the current spectrum is greater than the rejection threshold and less than an acceptance threshold, there is an ambiguity; the current spectrum is directed toward the block 1, arrow B, for a repeat pre-processing.

The diagnostic (block 9) consists in calculating the frequency of appearances of the different elements of the group constituted of the spectrums detected in the previous steps, blocks 1 to 8, and in determining if the warning level has been reached by one of the groups of the set of actives; if the sum of the diagnostics is greater than a pre-set threshold, the desired elements are identified and the desired result is obtained; otherwise, the diagnosed spectrum is directed towards the block 1, arrow C, for a repeat pre-processing.

The coalescence (block 10) allows to agglomerate the current spectrum with one of the training groups (block 11), or to create a new group (block 12); the purpose of the coalescence is to agglomerate a sufficient number of spectrums in order to create a new group, the potentiality of coalescence of the current spectrum with the training group probably being compared to the rest of the group.

The training group (block 11) undergoes a threshold detection (block 13) that defines a minimal size; if the threshold is reached, the training group is integrated into the set of actives and participates in the training process, otherwise, the current spectrums of said training group are directed towards the block 1, arrow D, for a repeat pre-processing.

Of course the method according to the invention comprises means for managing the groups of the set of actives.

In this example, a bidirectional chained list represents all of the groups, each group being defined by its identifier and its content; the inserting of a new group is performed following the destruction of the oldest group; nevertheless, some groups are indestructible.

1. Method of training and diagnostic with the aim of identifying a current spectrum allowing to detect chemical and/or biological substances in the atmosphere via flame spectrophotometry, said method comprising the following steps:
the analysis of the reduced data of the current spectrum in principal components;
the creation of a matrix representing all the projections of the set of actives;
the classification of all the projections of the set of actives into current groups;
the evaluation of the potential of affiliation of the current spectrum in all the current groups;
the affiliation of the current spectrum to one of the current groups of the set of actives if the potential of affiliation to said group of said current spectrum is greater than a pre-set threshold;
the setting off of the alarm if one of the current groups of the set of actives has a frequency of appearance of the different elements of the group greater than a pre-set threshold,
the remote rejection of the current spectrum and the agglomeration of one of the training groups, if said current spectrum is sufficiently different to extant forms so as to belong to a new group.

2. Method according to claim 1, comprising firstly comprises the following steps:
the modelling of the bottom of the flame (block 2);
the deleting of the bottom of the flame at the current spectrum (block 3);
the filtering of the obtained signal (block 4);
the standardising of the filtered spectrum (block 5);
the detecting of the current spectrum if the latter does not correspond to noise (block 6).

3. Method according to claim 1, wherein the projection of the current spectrum (block 7), on all the projection axes comprises the estimation of the parameters of said spectrum with the use of a series of simple regressions between the data of said current spectrum and a part of its parameters.

4. Method according to claim 1,
characterised in that the evaluation of the potential of affiliation of the projected spectrum (block 8) in relation to the different spectrum groups constituting a set of actives organised in distinct groups, comprises the following conditions:
if the potential of affiliation of the current spectrum is greater than a pre-set threshold, said spectrum undergoes the step known as the diagnostic step (block 9),
if the potential of affiliation of the current spectrum is less than a pre-set rejection threshold, said spectrum undergoes the step known as the coalescence step (block 10),
if the potential of affiliation of the current spectrum is greater than the rejection threshold and less than an acceptance threshold, there is an ambiguity; the current spectrum is directed toward a repeat pre-processing.

5. Method according to claim 4, wherein the diagnostic comprises the calculation of the frequency of appearances of the different elements of the group constituted of the spectrums detected and determining if the warning level has been reached by one of the groups of the set of actives.

6. Method according to claim 5, comprising the identifying of the diagnosed spectrum when the sum of the diagnostics is greater than a pre-set threshold.

7. Method according to claim 4, wherein the coalescence comprises the agglomeration of the current spectrum with one of the training groups (block 11) or the creation of a new group (block 12).

8. Method according to claim 7, comprising a threshold detection (block 13) that defines a minimal size for the training groups.

9. Method according to claim 8, comprising the integration of the training groups with the set of actives when the threshold has been reached.

10. Method according to claim 1, comprising a bi-directional chained list representing all of the groups, each group being defined by its identifier and its content; the inserting of a new group being performed following the destruction of the oldest group.

11. Method according to claim 10, wherein the chained list comprises indestructible groups.
